(19) United States
(12) Patent Application Publication
(10) Pub. No.: US 2004/0250129 A1
(43) Pub. Date: Dec. 9, 2004

(54) Systems and methods for managing a network-based service

(76) Inventors: James Clough, Boise, ID (US); Darrel D. Cherry, Boise, ID (US)

Correspondence Address: HEWLETT-PACKARK COMPANY, Intellectual Property Administration, P.O. Box 272400, Fort Collins, CO, 80527-2400, US

(21) Appl. No.: 10/453,712

(22) Filed: Jun. 3, 2003

(51) Int. Cl. H04L 9/00

(52) U.S. Cl. 713/201

(57) ABSTRACT

Disclosed are systems and methods for managing a network-based service. In one embodiment, a system and a method pertain to determining a client ID of a client, comparing the client ID to a client ID that is associated with a network address of the client, and, if the two client IDs are different, expiring an authorization code associated with the network address.

### BACKGROUND

In static networks, computing devices are assigned network addresses during network configuration. For dynamic networks, however, in which computing devices are connected and disconnected from the network, network addresses are assigned to the computing devices using, for instance, a dynamic host configuration protocol (DHCP) server. For example, when the computing device first connects to the network, the device sends a request on the network for a network address. In response to the request, the DHCP server assigns an address (e.g., Internet protocol (IP) address) to the computing device from a pool of available addresses.

Management of dynamic networks can present challenges that are not encountered in the static network scenario, particularly in situations in which computing devices are frequently connected to and disconnected from the network. This is the case with a hotel network to which guests connect. In that scenario, each computing device (i.e. client) is provided a network address upon connecting to the network. In some cases, an authorization code that enables the client to access and use a network-based service offered on the hotel network can be provided to the client. Such an authorization code facilitates identification and billing of the client, especially for situations in which the client accesses the service via a virtual private network (VPN) connection.

One problem with managing such a system is that it is often difficult to determine when a guest checks out due to the limited access that is provided to the property management system of the hotel. Therefore, it is likewise difficult to determine when to expire that guest's authorization code. Accordingly, after the guest checks out of the hotel, the guest may still be able to access and use services (e.g., printing services) offered on the hotel network. Although a crosscheck can be made when a service is accessed to confirm that the network address of the client that provided the authorization code is being used on the network, ostensibly indicating that the guest is still at the hotel, false determinations may result because that network address may have been reassigned to another guest who is connected to the network.

In another potential solution, authorization codes may be timed-out after the expiration of a predetermined period of time. One drawback of such automatic expiration is that it may require guests who stay at the hotel beyond that predetermined time period to manually renegotiate for new codes. In a variation of that solution, such renegotiations could be required each time the client connects to the network. Such solutions are inefficient, however, and may be difficult to achieve when VPN connections are used. Moreover, repeatedly assigning new authorization codes can result in the generation and required maintenance of very large databases that contain obsolete information.

In yet another solution, the network-based service could be customized for each application so that it is tightly coupled to the hotel management system in which it is implemented. However, such a solution is prohibitively expensive and difficult to implement.

### SUMMARY

Disclosed are systems and methods for managing a network-based service. In one embodiment, a system and a method pertain to determining a client ID of a client, comparing the client ID to a client ID that is associated with a network address of the client, and, if the two client IDs are different, expiring an authorization code associated with the network address.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system that supports a network-based service.

FIG. 2 is a block diagram of an embodiment of a computing device shown in FIG. 1.

FIG. 3 is a block diagram of an embodiment of a printing device shown in FIG. 1.

FIG. 4 is a flow diagram that illustrates an embodiment of operation of a client in discovering and registering with a network-based service on a local network.

FIG. 5 is a flow diagram that illustrates an embodiment of operation of a service manager in registering a client and managing authorization codes.

FIG. 6 is a flow diagram that illustrates an embodiment of operation of a service manager in determining whether a client is authorized to use a network-based service.

### DETAILED DESCRIPTION

As described above, current procedures for managing authentication codes present several drawbacks. As is described in this disclosure, however, the assignment and expiration of authorization codes can be automatically managed by updating a client database upon client registration. As is discussed below, such management further avoids uncontrolled growth of the client database.

Disclosed herein are example systems and methods that facilitate the management of a network-based service. Although this management can be implemented in any network-based service, such management is described in the context of a network-based printing service. It is to be understood, however, that the printing service implementation is provided for purposes of example only to facilitate description of the disclosed systems and methods.

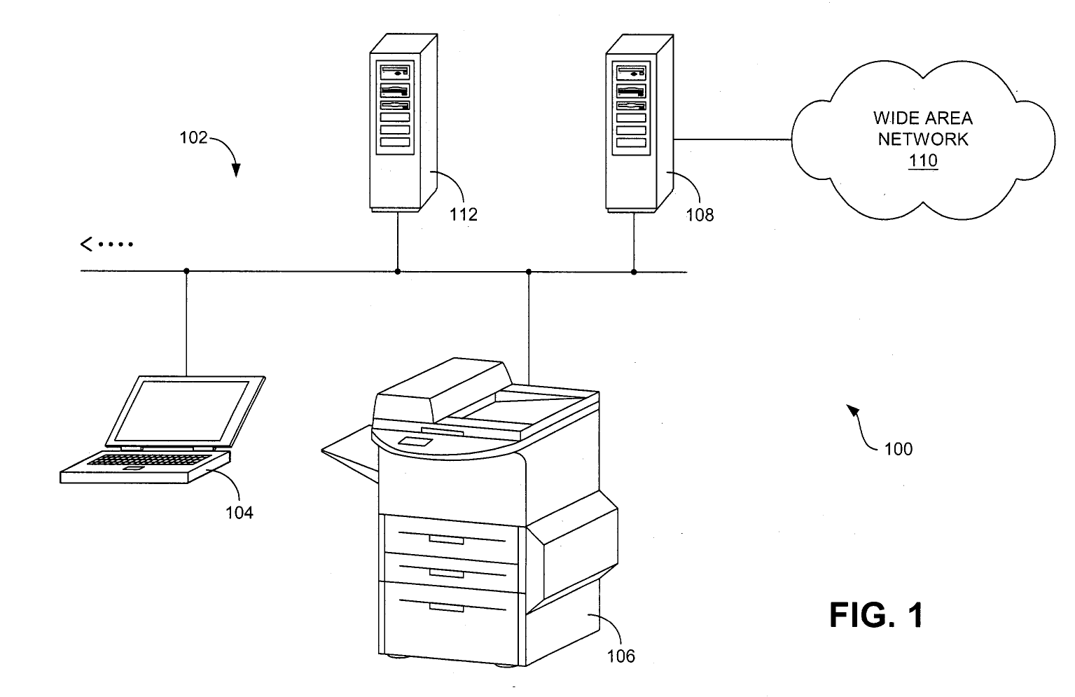

Referring now in more detail to the drawings, in which like numerals indicate corresponding parts throughout the several views, FIG. 1 illustrates an example system 100 that facilitates a network-based public printing service. As indicated in this figure, the system 100 includes a local or internal network 102 to which a computing device 104, a printing device 106, and a server computer 108 are connected.

The computing device 104 can be a notebook (or “laptop”) computer. More generally, however, the computing device 104 comprises any device having processing and communication capabilities that a user may remove from the internal network 102 and use remotely, or use locally and establish a virtual private network (VPN) connection. Accordingly, the computing device 104 can, alternatively, comprise one of a personal digital assistant (PDA), tablet computer, mobile telephone, digital camera, etc. Irrespective of its configuration, the computing device 104 is connectable to the internal network 102 such that the computing device can communicate with one or both of the printing device 106 and the server computer 108. This connection may comprise either a wired connection or a wireless connection (e.g., via a radio frequency (RF) communication protocol). Stored on the computing device 104 is client software (or firmware) that is used to access and use the public printing service, which is facilitated by a printing service manager.

The printing device 106 comprises any device that can receive print jobs via the internal network 102 and generate hardcopy documents associated with the received jobs. By way of example, the printing device 106 comprises a laser printer. However, other configurations are possible. For instance, the printing device 106 can be a multi-function peripheral (MFP) device that is capable of printing as well as performing other tasks such as copying, scanning, faxing, emailing, etc. As is described in greater detail below, the printing service manager that facilitates the public printing service can be embedded within the printing device 106.

The server computer 108 links the internal network 102 to an external wide area network (WAN) 110, such as the Internet, and therefore acts as a gateway between the internal network and the WAN. As is described below, the server computer 108 is configured to intercept initial communications directed at devices located outside of the internal network 102 (i.e. on the WAN 110). Such interception may be used to offer printing services to the user.

In addition to acting as the network gateway, the server computer 108 (or a separate computer if desired) may be used to provide the network address (e.g., Internet protocol (IP) address) of the printing service manager. Furthermore, the server computer 108 may facilitate billing for rendered printing services by, for instance, posting printing charges to a bill (e.g., hotel bill) or forwarding billing information to a credit card processing service connected to the WAN 110. It is noted that, in some embodiments, the printing service manager, or a portion thereof, may exist on the server computer 108 or another device connected to the network 102.

As is further indicated in FIG. 1, the system 100 optionally includes a dynamic host configuration protocol (DHCP) server 112. The DHCP server 112, when provided, is configured to assign IP addresses to clients on the internal network 102, such as a client executing on the computing device 104. Although a separate DHCP server 112 is illustrated in FIG. 1, the functionality provided by that server can be provided by another device, for example the server computer 108.

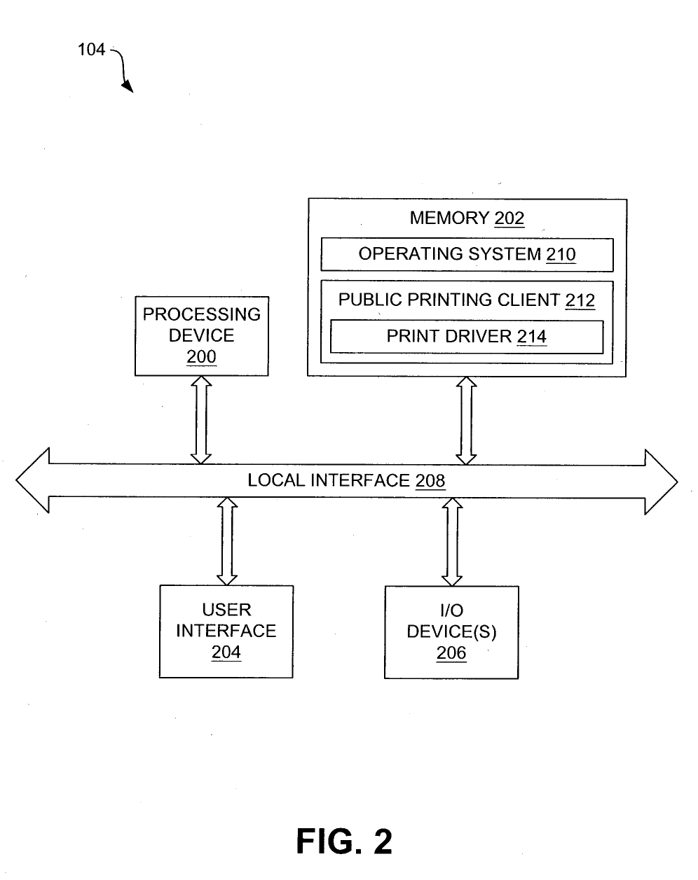

FIG. 2 is a block diagram illustrating an example architecture for the computing device 104 shown in FIG. 1. As indicated in FIG. 2, the computing device 104 comprises a processing device 200, memory 202, a user interface 204, and at least one input/output (I/O) device 206. Each of these components is connected to a local interface 208 that, for instance, comprises one or more internal buses.

The processing device 200 is adapted to execute commands stored in memory 202 and can comprise a general-purpose processor, a microprocessor, one or more application-specific integrated circuits (ASICs), a plurality of suitably configured digital logic gates, or other electrical configurations that coordinate the overall operation of the computing device 104. The memory 202 comprises any one or a combination of volatile memory elements (e.g., random access memory (RAM)) and nonvolatile memory elements (e.g., Flash memory, hard disk, etc.) that store or cache data.

The user interface 204 comprises the tools with which user data and commands are input into the computing device 104. In situations in which the computing device 104 comprises a notebook computer, the user interface 204 at least comprises a keyboard and a display. In other embodiments, the user interface may comprise one or, more of function keys, buttons, a touch-sensitive display, and a stylus.

The one or more I/O devices 206 facilitate communications with other devices and may include one or more serial, parallel, small computer system interface (SCSI), universal serial bus (USB), Ethernet, or IEEE 1394 (e.g., Firewire™) components, as well as one or more of a modulator/demodulator (e.g., modem), network card, wireless (e.g., RF) transceiver, or other communication component.

The memory 202 includes various programs, in software and/or firmware, including an operating system 210. The operating system 210 controls the execution of other software and provides scheduling, input-output control, file and data management, memory management, and communication control and related services. In addition, the memory 202 comprises a public printing client 212. The public printing client 212 operates in conjunction with the printing service manager to facilitate public printing. By way of example, the public printing client 212 can be downloaded from the printing service manager or from a suitable source on the WAN 110. In any case, however, once stored on the computing device 104, the public printing client 212 can be used to facilitate public printing on any network in which an appropriate printing service manager is provided, thereby providing a substantially universal printing solution.

As is further identified in FIG. 2, the public printing client 212 includes a print driver 214 that is used to translate documents into an appropriate print format. Alternatively, however, the driver 214 could comprise part of the operating system 210. In preferred embodiments, the print driver 214 is a universal driver that can be used in conjunction with substantially any printing device that may be accessed via a compatible printing service manager.

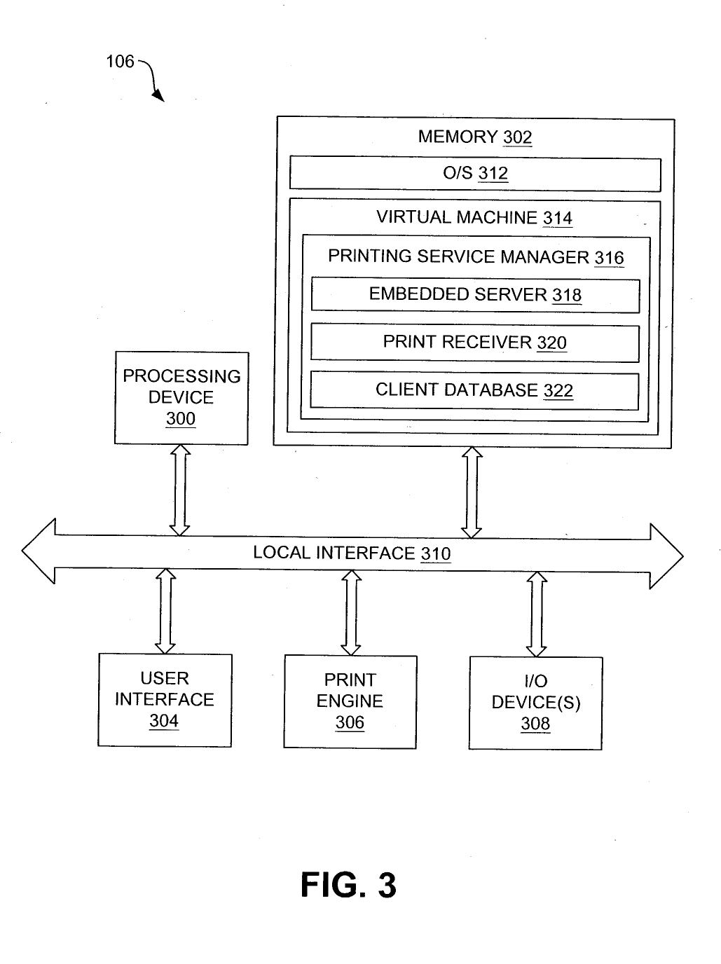

FIG. 3 is a block diagram illustrating an example architecture for the printing device 106 shown in FIG. 1. As indicated in FIG. 3, the printing device 106, like the computing device 104, comprises a processing device 300, memory 302, a user interface 304, and at least one I/O device 308, each of which is connected to a local interface 308. In addition, however, the printing device 106 comprises a print engine 306.

The processing device 300, memory 302, and I/O devices 308 have similar configurations to like-named components of the computing device 104 described in relation to FIG. 2. The user interface 304 comprises the components with which users input commands and modify device settings, such as a control panel that incorporates a display (e.g., liquid crystal display (LCD)) and a series of keys or buttons.

The memory 302 comprises various programs, in software and/or firmware, including an operating system 312 and, in this embodiment, a virtual machine 314. The operating system 312 contains the various commands that are used to control the general operation of the printing device 106. The virtual machine 314 is a program that functions as a self-contained operating environment and facilitates operation of a printing service manager 316 that, as noted above, facilitates public printing. Although a virtual machine is explicitly shown and identified, its functionality could, alternatively, be provided by software or firmware stored in the printing device 106. In the embodiment of FIG. 3, however, the manager 316 comprises an applet (e.g., written in the Chai™ programming language of the Hewlett-Packard Company) that includes an embedded server 318 and a print receiver 320. As mentioned above, although the printing service manager 316 is shown as executing on the printing device 106, it could alternatively be provided on a separate device, such as the server computer 108 or another device connected to the internal network 102, if desired.

The embedded server 318 is configured to serve network pages, for instance Web pages, to requesting devices such as the computing device 104. Such pages contain information for the user as to how to use the public printing system hosted by the printing service manager 316, how to obtain public printing client software, the cost of the printing services, the methods of paying for those services, etc.

The print receiver 320 is a module that is configured to receive print jobs transmitted to the printing device 106 via the internal network 102. By way of example, the print receiver 320 is specifically configured to receive hypertext transfer protocol (HTTP) and/or secure HTTP (HTTPS) communications. These communications can be received via an internal port and an external port that each has its own network address (e.g., universal resource locator (URL)) that is used to access the port. In some embodiments, the internal port and the external port may comprise the same port. When a print job is received, the print receiver 320 forwards the job to the print engine 306 for printing.

In addition to the embedded server 318 and the print receiver 320, the printing service manager 316 may further comprise, or access, a client database 322. As is described below, the client database 322 comprises any client information that is recorded through registration of clients (e.g., the public printing client 212), and is used to manage the assignment and expiration of authorization codes used by clients to establish the clients' credentials to use the network-based service (e.g., printing service).

Various programs (i.e. logic) have been described herein. These programs can be stored on any computer-readable medium for use by or in connection with any computer-related system or method. In the context of this document, a “computer-readable medium” is any electronic, magnetic, optical, or other physical device or means that contains or stores a computer program for use by or in connection with a computer-related system or method. These programs can used by or in connection with an instruction execution system, apparatus, or device, such as a computer-based system, processor-containing system, or other system that can fetch the instructions from the instruction execution system, apparatus, or device and execute the instructions.

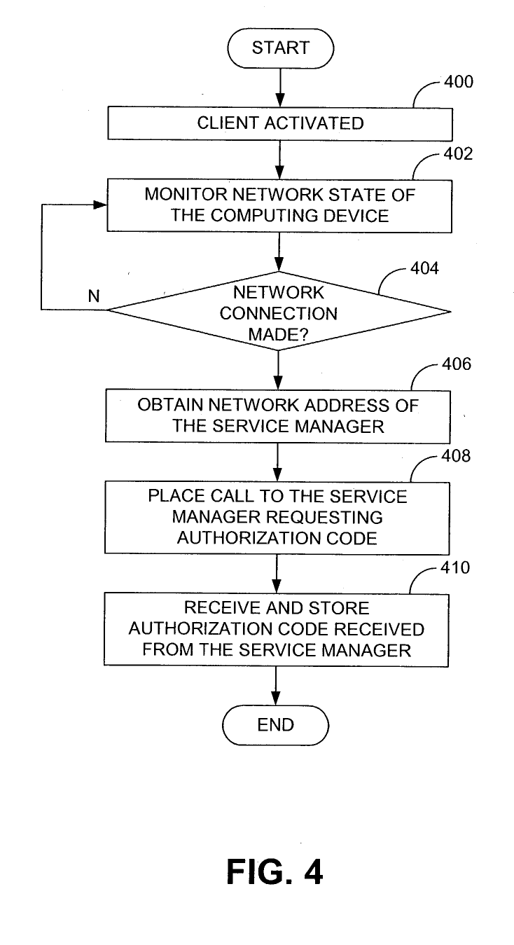

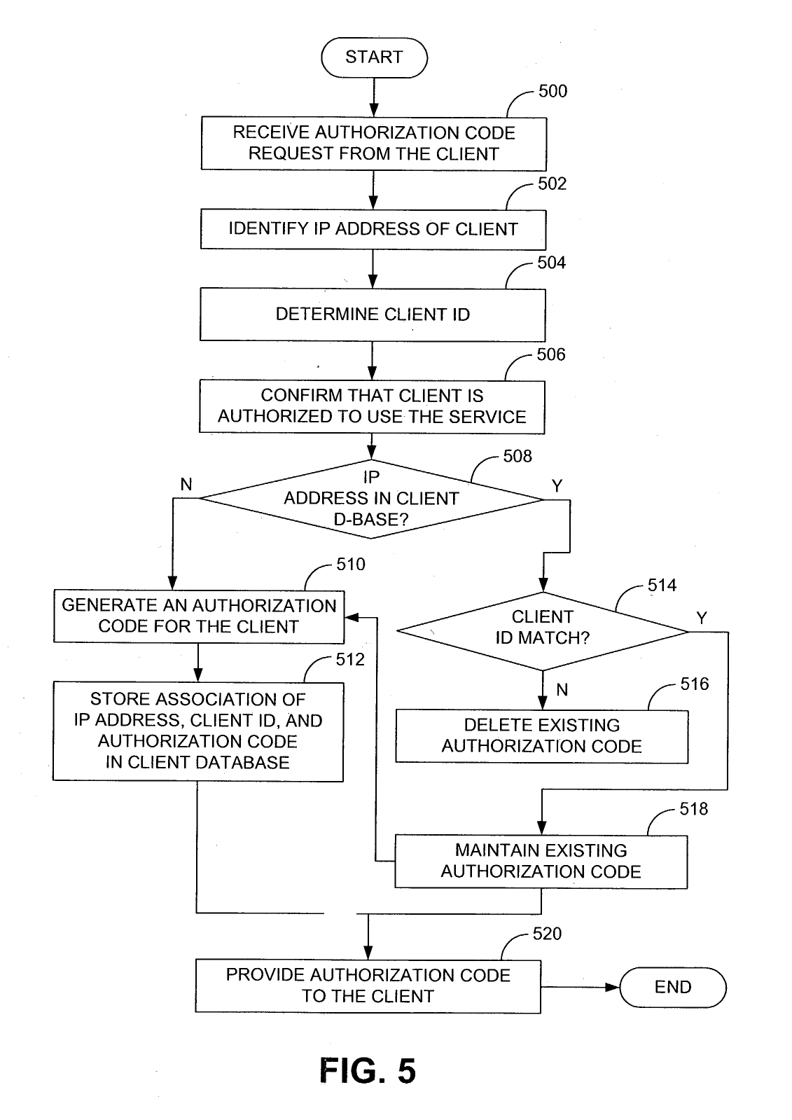

FIG. 4 is a flow diagram that illustrates an embodiment of discovery of and registration with a network-based service, such as a printing service. More particularly, illustrated is an example of operation of a client in discovering and registering with a network-based service on a local network. As is described below, through this discovery process, the client is registered with the network-based service and is automatically provided with information that can be used to authenticate and authorize the client when it later attempts to use the service from a remote location, or attempts to use the service via a VPN connection (in which case the client appears to be remotely located). Moreover, as is discussed with reference to FIG. 5, authentication codes used to access and use the service can be managed as a consequence of the registration process.

It is noted that process steps or blocks in the flow diagrams of this disclosure may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

Beginning with block 400, a client (e.g., public printing client 212 (FIG. 2)) stored on a computing device is activated. This activation occurs, for instance, when the computing device is powered and booted. In any case, however, once the client is activated it monitors the network state of the computing device, as indicated in block 402, so that the client can detect when the computing device is connected to a network (e.g., internal network 102 (FIG. 1)) that supports the network-based service. By performing this monitoring, it can be determined, as indicated in decision block 404, whether a network connection has been made. If not, flow returns to block 402 at which the client, which runs in the background on the computing device, continues to monitor the device network state.

If a network connection is detected, flow continues from decision block 404 to block 406 at which the client obtains the network address of a service manager (e.g., printing service manager 316 (FIG. 3)) that manages the network-based service. That address can be obtained, for example, by performing a domain name service (DNS) lookup for a domain name associated with the service. However, other methods may be used to obtain the service manager address. For instance, a service location protocol (SLP) request can be sent to an appropriate device, a request can be generally broadcast on the internal network 102, or the address can simply be located from an appropriate directory.

Assuming that the service is available on the network, the client places a call to the service manager (e.g., to an IP address of the manager) to communicate with the service manager, as indicated in block 408. Such a communication can be supported using an appropriate network protocol, such as HTTP or HTTPS. It is noted that, in the process described above, the client is proactive in locating the network-based service. Alternatively, however, the client may be relatively passive and the network-based service may instead take an active role in identifying the client and initiating communications with the client.

Referring now to FIG. 5, which illustrates an example of operation of the service manager (e.g., the printing service manager 316 (FIG. 3)) in registering the client that made the call identified in block 408 of FIG. 4. Beginning with block 500 of FIG. 5, the service manager receives the call from the client. After receiving this call, the service manager identifies the IP address of the client, as indicated in block 502, and determines the client ID, as indicated in block 504. By way of example, the client ID comprises the media access control (MAC) address of the computing device on which the client executes, and is obtained from the server computer 108. More generally, however, the client ID comprises any information that uniquely identifies the device on which the client executes.

After determining the IP address and client ID, the service manager confirms that the client (and therefore the user) is authorized to use the service, as indicated in block 506. This confirmation can be made by, for example, determining whether the client is connected to the local network and, if so, determining what location (e.g., port) on the network the client is connected, determining whether the client is logged in to the network, etc. Assuming that the client is authorized to use the service, the service manager can then determine whether the client IP address is currently stored within the client database 322 (FIG. 3), as indicated in decision block 508.

If the client IP address is not currently contained within the client database 322, the service manager generates an authorization code for the client, as indicated in block 510. By way of example, the authorization code comprises a randomly-generated number that is used as a “shared secret.” Once the authorization code is generated, the association between the client IP address, a client ID, and the generated authorization code is stored in the client database 322, as indicated in block 512. At this point, flow continues down to block 520 discussed below.

Returning to decision block 508, if the client IP address is currently stored in the client database 322, flow continues to decision block 514 at which it is determined whether the client ID determined in block 504 matches a client ID associated with the client IP address that is currently stored in the client database 322. If not, the client is likely a different client (e.g., a different hotel guest) and the authorization code associated with the IP address is deleted (i.e. expired), as indicated in block 516. At this point, flow continues on to block 510 described above at which a new authorization code is generated for the client.

If, at decision block 514, the client ID determined in block 504 matches the client ID stored in the client database 322 for the IP address determined in block 502, flow continues to block 518 at which the existing authorization code assigned to the client is maintained. In such a case, or after a new entry is stored in the client database 322 (block 512), the authorization code is provided to the client, as indicated in block 520. Flow for the registration/authorization code maintenance process is then completed.

Returning to FIG. 4, the authorization code that was generated (block 510) or confirmed (block 514) by the service manager is received and stored by the client, as indicated in block 410. At this point, the client is configured to access and use the network-based service via a virtual private network (VPN) connection that extends from the internal network 102 to a remote network.

With the registration process described above, the client database 322 is automatically updated whenever a client registers with the service, without having to tightly couple the service to the local system in which it is used, such as a hotel management system. As a consequence, the database is automatically maintained and its number of entries is always limited to the number of IP address available for distribution. Therefore, uncontrolled growth of the database 322 is avoided, as is the need to allocate a large amount of memory space for its storage.

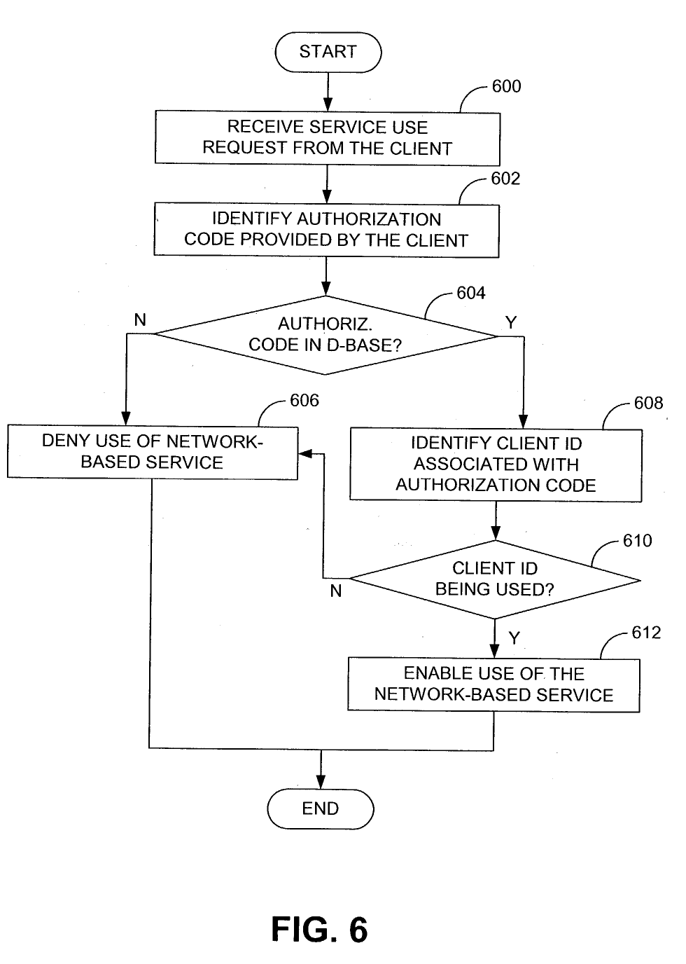

FIG. 6 is a flow diagram that illustrates an embodiment of operation of the service manager in determining whether to enable use of the service by a client that has accessed the service from a location that appears to be remote. In such a case, the client could be attempting to access the service from outside the internal network (in which case use of the service is not permitted) or attempting to access the service from within the internal network via a VPN connection (in which case use of the service is permitted). In situations in which the service is a public printing service, the service manager may comprise the printing service manager 316 (FIG. 3).

Beginning with block 600 of FIG. 6, the service manager receives a request to use the network-based service. The request may comprise, for example, initial packets of a print job transmitted to a port of the service manager. Upon receiving the request, the service manager identifies the authorization code provided by the client, as indicated in block 602. By way of example, this code can be embedded in a URL that was used by the client to access the service manager. Next, with reference to decision block 604, the service manager determines whether the authorization code provided by the client is contained in the client database 322 (FIG. 3). If not, flow continues to block 606 at which the client is denied use of the network-based service. If the authorization is contained in the database, however, flow continues to block 608 at which the service manager identifies the client ID associated with the authorization code by performing a lookup process in relation to the client database 322.

Once the client ID stored in the database 322 has been identified, it is determined in decision block 610 whether that client ID is present on the internal network. If so, the client is local and is therefore authorized to use the service. Therefore, the service manager enables use of the network-based service, as indicated in block 612. However, if the client ID is not being used on the internal network, the client is attempting to use the service from a remote location (e.g., outside of a hotel network) and use of the service is denied (block 606).

Through the management described above, remote users are prevented from using the network-based service after their privileges have expired. Therefore, in the hotel context, hotel guests are permitted to use the service, even if they have established a VPN connection, but former hotel guests are prevented from accessing the service once they have left the hotel.

What is claimed is:

1. A method for managing a network-based service, comprising:
identifying a network address of a client;
determining if the network address is stored in a client database; and
if the network address is stored in the client database,
determining a client ID of the client,
comparing the determined client ID to a client ID stored in the client database in association with the network address, and
if the two client IDs are different, expiring an authorization code associated with the network address.

2. The method of claim 1, wherein identifying a network address comprises identifying an Internet protocol (IP) address of the client.

3. The method of claim 1, wherein determining a client ID comprises determining a media access control (MAC) address of a computing device on which the client executes.

4. The method of claim 1, wherein determining a client ID comprises requesting the client ID from a device in communication with infrastructure of a network on which the service is provided.

5. The method of claim 1, further comprising generating a new authorization code for the client after expiring an authorization code.

6. The method of claim 5, further comprising storing an association of the network address, the client ID, and the new authorization code in the client database.

7. The method of claim 6, further comprising providing the new authorization code to the client.

8. The method of claim 1, wherein if the network address is not stored in the client database, generating a new authorization code for the client, storing an association of the network address, the client ID, and the new authorization code in the client database, and providing the new authorization code to the client.

9. The method of claim 1, wherein if the two client IDs are the same, maintaining an existing authorization code in the client database.

10. The method of claim 1, further comprising, prior to identifying a network address of a client, receiving a registration request from the client.

11. A system, comprising:
a client that is configured to request registration with a network-based service; and
a service manager that registers clients with the service, the manager being configured to determine a client ID of a client and compare it to a client ID that is associated with a network address of the client and stored in a client database, and, if the two client IDs are different, expire an authorization code associated with the network address.

12. The system of claim 11, wherein the service manager is configured to identify an Internet protocol (IP) address of the client.

13. The system of claim 11, wherein the service manager is configured to determine a media access control (MAC) address of a computing device on which the client executes.

14. The system of claim 11, wherein the service manager is further configured to generate new authorization codes.

15. The system of claim 14, wherein the service manager is further configured to store an association of the network address, the client ID, and a new authorization code in the client database.

16. A system for managing a network-based service, comprising:
means for identifying a network address of a client requesting registration with the service;
means for determining a client ID of the client;
means for comparing the client ID to a client ID stored in association with the network address of the client; and
means for expiring an authorization code associated with the network address when the client IDs do not match.

17. The system of claim 16, further comprising means for generating new authorization codes.

18. The system of claim 17, further comprising means for storing an association between the network address, the client ID, and a new authorization code.

19. The system of claim 18, further comprising means for providing the new authorization code to the client.

20. A service manager stored on a computer-readable medium, comprising:
logic configured to identify a network address of a client;
logic configured to determine a client ID of the client;
logic configured to compare the client If) to a client ID that is stored in a client database and associated with the network address; and
logic configured to expire an authorization code associated with the network address when the client IDs do not match.

21. The manager of claim 20, further comprising logic configured to generate a new authorization code.

22. The manager of claim 21, further comprising logic configured to store an association between the network address, the client ID, and the new authorization code.

23. The manager of claim 22, further comprising logic configured to provide the new authorization code to the client.
